(19) United States
(12) Patent Application Publication
(10) Pub. No.: US 2021/0224853 A1
(43) Pub. Date: Jul. 22, 2021

(54) Methods and Apparatus for Generating a Location-Conscious Mobile Banner

(71) Applicant: Chalk Media Holdings, dba Chalk Digital, San Diego, CA (US)

(72) Inventors: Chandra Shekhar Kholia, San Diego, CA (US); Craig Michael Hagopian, San Diego, CA (US); Satoru Yukie, Rancho Santa Fe, CA (US)

(21) Appl. No.: 17/119,738

(22) Filed: Dec. 11, 2020

Related U.S. Application Data
(63) Continuation of application No. 16/273,019, filed on Feb. 11, 2019, now abandoned.
Application No. 16/273,019 is a continuation of application No. 14/542,511, filed on Nov. 14, 2014, now abandoned.
(60) Provisional application No. 61/094,171, filed on Sep. 4, 2008.

(51) Int. Cl. G06Q 30/02; H04W 4/21; H04W 4/18; H04W 4/021

(52) U.S. Cl. CPC G06Q 30/0261; H04W 4/21; G06Q 30/0267; H04W 4/021; H04W 4/18

(57) ABSTRACT

In some embodiments, a user can create a location-conscious mobile banner. The user can specify the appearance and content of the location-conscious mobile banner, and can also specify where and when the location-conscious mobile banner is provided to other users, and/or a type of campaign to initiate. A mobile application may communicate with a server in order to store and/or distribute the location-conscious mobile banner for display within mobile applications and/or other media. The server can also provide the user with statistics about the location-conscious mobile banner, and can allow the user to dynamically alter portions of the location-conscious mobile banner and/or the campaign criteria for the location-conscious mobile banner, based on the statistics. The server may also facilitate interaction between other users viewing the location-conscious mobile banner, and the information incorporated within the location-conscious mobile banner.

### FIELD

The systems and methods of the disclosure relate to methods and apparatuses for creating location-based banners within mobile applications.

### BACKGROUND

Various entities (e.g., people and/or businesses) often wish to provide information, goods, and/or services to other entities within a geographic location. Conventional methods of providing such information, however, can be ineffective or costly. For example, conventional online advertising can reach a large number of people, but an entity often may not have control over various aspects of the advertisement, such as where, geographically, the advertisement is distributed, during what time period (e.g., within a particular day, within a particular week, and/or a similar time frame) the advertisement may be provided to other entities, and/or what platform the advertisement can be provided on (e.g., conventional online advertisements often cannot be displayed in mobile applications, and/or displayed using at least some of the criteria described above). Conventional advertising is also often ill-suited for users with non-economic information they wish to show others, such as information about missing pets, community announcements, neighborhood events, weather updates (e.g., severe weather notifications) and other such information.

Additionally, physical advertisement and/or notice campaigns such as using signboards, posters, flyers can be costly, and while they can more specifically target a particular location, such advertisements can often be overlooked by other entities, and/or do not provide a convenient way to process the advertisement (e.g., an entity may not be able to keep a copy of the advertisement, view details about the entity providing the advertisement, and/or the like).

Thus, a need exists for allowing users to provide information (including advertisements and notices) to entities within a particular location and time period, and to allow users to provide such information on mobile platforms.

### SUMMARY

In some embodiments, a user can create a location-conscious mobile banner, e.g., using a mobile application configured to operate on an electronic device (including but not limited to a mobile phone, a laptop, a tablet, a Personal Digital Assistant, and/or a like electronic device). The user can create a location-conscious mobile banner to advertise goods and/or services, local events, notifications which can be relevant to others in the area, and/or the like. Users can specify the appearance and content of the location-conscious mobile banner, and can also specify where and when the location-conscious mobile banner is provided to other users, and/or a type of campaign to initiate.

The mobile application can communicate with a server in order to store and/or distribute the location-conscious mobile banner for display within mobile applications and/or other media. The server can also provide the user with statistics about the location-conscious mobile banner, and may allow the user to dynamically alter portions of the location-conscious mobile banner and/or the campaign criteria for the location-conscious mobile banner, based on the statistics. The server may also facilitate interaction between other users viewing the location-conscious mobile banner, and the information incorporated within the location-conscious mobile banner.

In one aspect the disclosure relates to a location-conscious mobile banner apparatus. The apparatus includes a location-conscious mobile banner database configured to store location-conscious mobile banner data and a location-conscious mobile banner template. The apparatus further includes a capturing server operatively coupled to the location-conscious mobile banner database and configured to receive a first request from a user device to create a location-conscious mobile banner and to responsively retrieve the location-conscious mobile banner template from the location-conscious mobile banner database. The capturing server may be configured to send to the user device the location-conscious mobile banner template and to receive location-conscious mobile banner data from the user device wherein the location-conscious mobile banner data is consistent with the location-conscious mobile banner template. A delivery server is operatively coupled to the capturing server and configured to receive from the capturing server the location-conscious mobile banner data, the delivery server being configured to create a location-conscious mobile banner using the location-conscious mobile banner data and to send the location-conscious mobile banner to a publisher server. The publisher server is configured to send the location-conscious mobile banner to at least one mobile device for display by a mobile application executed by the at least one mobile device.

In another aspect the disclosure pertains to a non-transitory processor-readable medium storing code representing instructions to be executed by a processor, the code comprising code to cause the processor to: receive, from a user device, an indication of interest in creating a location-conscious mobile banner; retrieve, from a location-conscious mobile banner database, at least one location-conscious mobile banner template based on information included within the indication of interest; provide the at least one location-conscious mobile banner template to the user device; receive location-conscious mobile banner template input from the user device, the location-conscious mobile banner template input including geolocation data; create a location-conscious mobile banner using the location-conscious mobile banner template input from the user; and send the location-conscious mobile banner for delivery to at least one mobile application executed by a mobile device.

The disclosure also relates to a non-transitory processor-readable medium storing code representing instructions to be executed by a processor, the code comprising code to cause the processor to: receive, from a user device, location-conscious mobile banner input; create a location-conscious mobile banner using the location-conscious mobile banner input; send the location-conscious mobile banner for display in at least one mobile application; receive location-conscious mobile banner access statistics from the location-conscious mobile banner in the at least one mobile application; and output the location-conscious mobile banner access statistics to the user device via a graphical user interface.

### BRIEF DESCRIPTION OF THE DRAWINGS

FIG. 1 is a flow diagram illustrating creating a location-conscious mobile banner, according to an embodiment.

FIG. 2 is a logic flow diagram illustrating creating a location-conscious mobile banner, according to an embodiment.

FIG. 3 is a block diagram illustrating a banner server, according to an embodiment.

FIG. 4 is a block diagram illustrating a banner server, according to an embodiment.

FIGS. 5A-C are block diagrams illustrating a location-conscious mobile banner database, according to an embodiment.

FIG. 6 is a screenshot diagram illustrating user account functionality, according to an embodiment.

FIG. 7 is a screenshot diagram illustrating selecting a type of location-conscious mobile banner, according to an embodiment.

FIG. 8 is a screenshot diagram illustrating creating a location-conscious mobile banner, according to an embodiment.

FIG. 9 is a screenshot diagram illustrating specifying a landing page for the location-conscious mobile banner, according to an embodiment.

FIGS. 10-11 are screenshot diagrams illustrating a landing page for the location-conscious mobile banner, according to an embodiment.

FIG. 12 is a screenshot diagram illustrating providing settings metadata for a location-conscious mobile banner, according to an embodiment.

FIG. 13 is a screenshot diagram illustrating location-conscious mobile banner statistics in a reporting dashboard, according to an embodiment.

FIG. 14 is a screenshot diagram illustrating displaying statistics data on a map in a reporting dashboard, according to an embodiment.

### DETAILED DESCRIPTION OF THE DRAWINGS

In some implementations, users may create a location-conscious mobile banner for advertisements, local notifications, and/or for various other purposes. For example, a clothing store can create a location-conscious mobile banner advertising a sale on clothing, e.g., within a particular geographic location, within a specified time period, and/or other such criteria. As another example, a person can also create a location-conscious mobile banner, e.g., to notify others within a geographical area that a pet and/or child is missing, neighborhood events (e.g., block parties, flea markets, construction notices, school events), notices about open houses, and/or similar information. A location-conscious mobile banner can expire after the specified time period has lapsed, and can be renewed and/or resubmitted any number of times after expiring, e.g., by providing a new time period for the location-conscious mobile banner, by changing an aggregate budget for the location-conscious mobile banner, and/or the like.

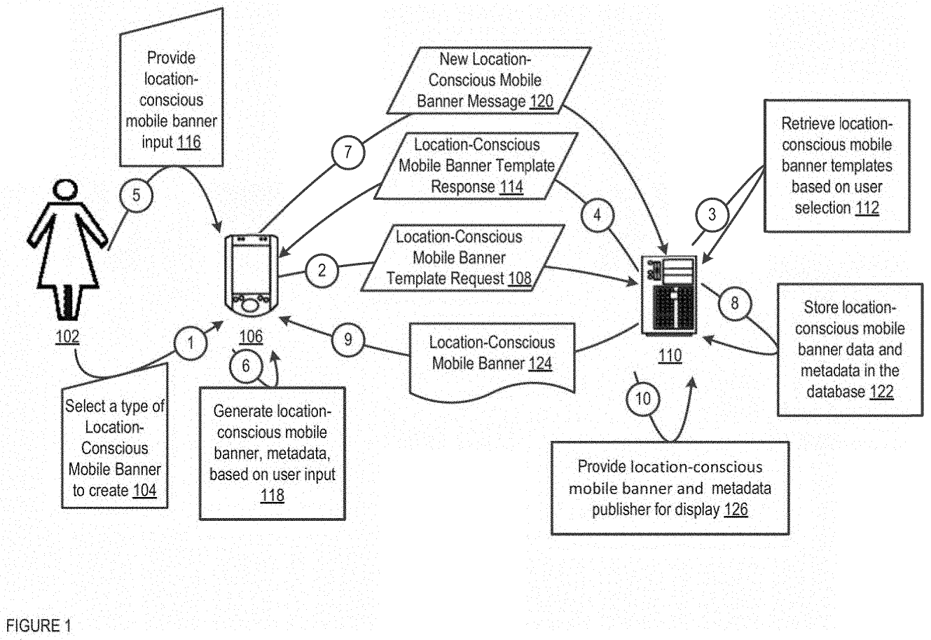

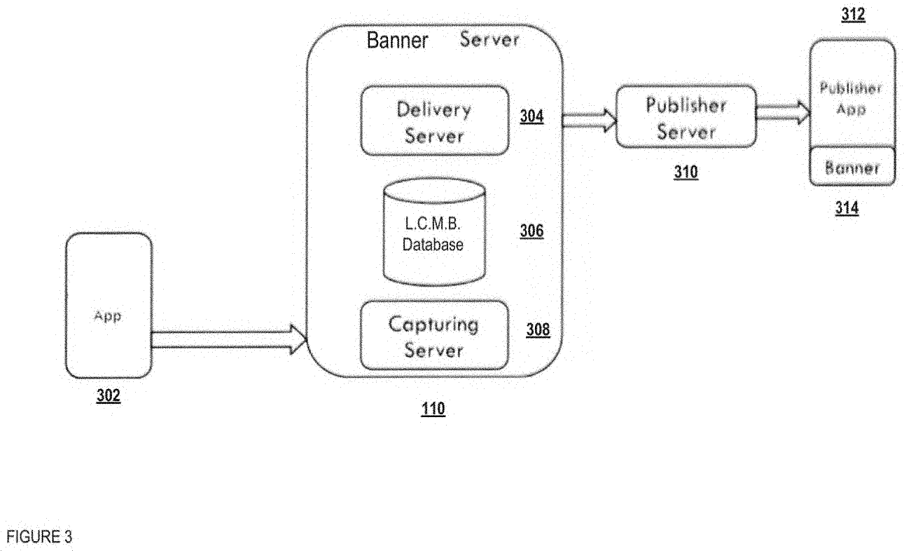

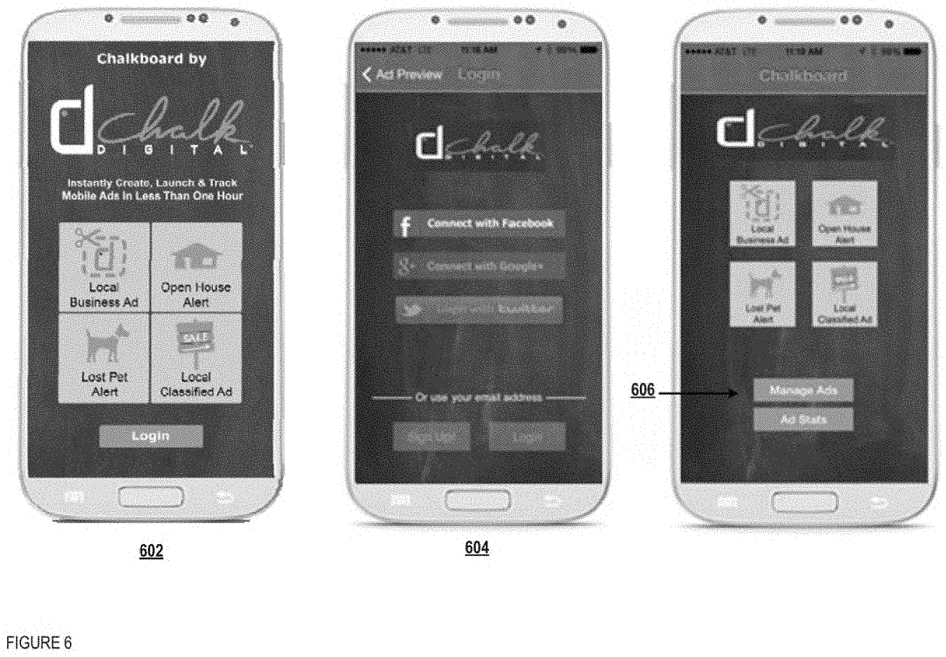

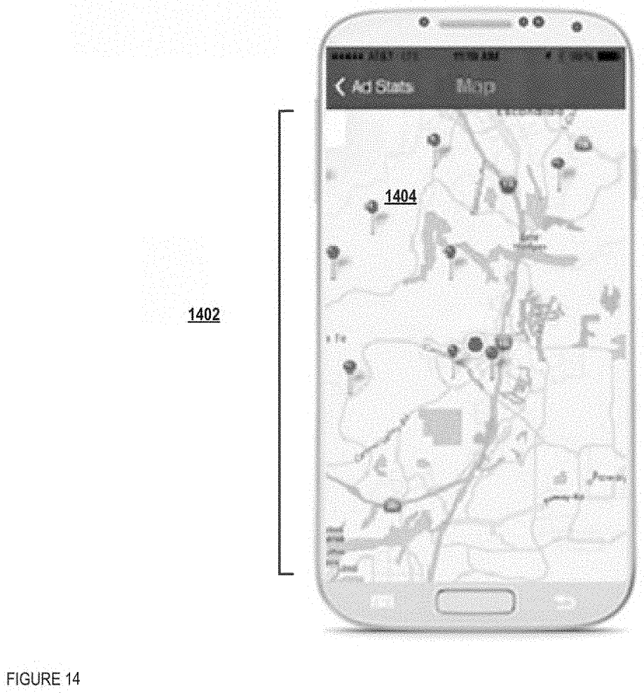

As is discussed in greater detail below, the user may be able to use a mobile application 302 (e.g., see at least FIG. 3) on their electronic device in order to create a location-conscious mobile banner. As shown in FIG. 6, the mobile application may include a splash page 602, from which a user can immediately post certain forms of location-conscious mobile banner (e.g., missing pet and/or children alerts), and/or from which the user can log into her account. If the user does not have an account, the user can create one, e.g., using credentials from social networking and/or like websites 604, and/or by filling out a signup form which can include text fields for information such as a username, email address, password, name, and/or similar information. The user may then create a new location-conscious mobile banner in the manner described by, for example, FIG. 1, manage an existing location-conscious mobile banner, and view statistics for a location-conscious mobile banner as described below with reference to FIG. 14.

Using the mobile application 302, users can create advertisement and/or notice campaigns using a mobile device interface. Such an interface may comprise, for example, a location-conscious mobile banner template and/or selectable options enabling a user to customize the location-conscious mobile banner. The mobile application 302 may also allow users to specify a geographic community in which to display the location-conscious mobile banner and the manner in which the banner is to be published, thereby obviating the need to create and distribute physical materials within a community.

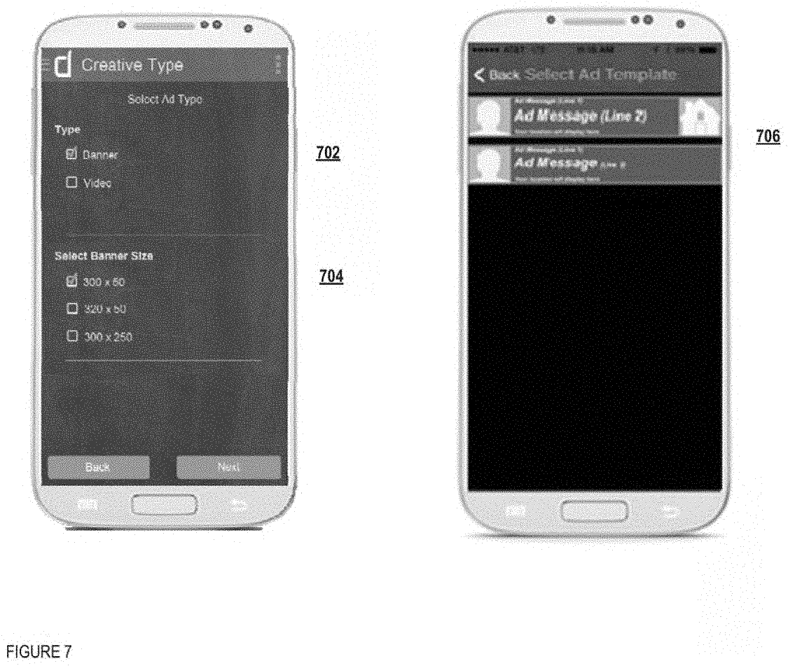

Turning now to FIG. 1, an exemplary process flow diagram is provided which illustrates creating a location-conscious mobile banner. In some implementations, a user 102 can select 104 a type of location-conscious mobile banner to create (e.g., a static banner, an animated banner, a banner including a video, and/or the like) within a mobile application 302 instantiated on the user's electronic device 106. Referring to FIG. 7, for example, in addition to allowing the user 102 may also select a type of location-conscious mobile banner 702, the user 102 can also be able to select a banner size 704. In some implementations the user 102 can also specify the industry for which the location-conscious mobile banner is being created (if any), the general topic of the location-conscious mobile banner, and/or similar information.

Referring back to FIG. 1, the electronic device 106 can generate and send a location-conscious mobile banner template request 108 to a banner server 110, including user information, and/or the selected type of location-conscious mobile banner that the user 102 selected. The banner server 110 can retrieve 112 relevant templates for the user 102, based on the type of location-conscious mobile banner the user 102 wishes to create, and can send the template data to the mobile application, e.g., via a location-conscious mobile banner template response 114. Each template may be its own data structure, e.g., encoded in XML, JSON, and/or a similar format, and may include various fields and/or layouts for textual data, images, video and/or animation components, and/or other structural details for constructing a location-conscious mobile banner. In some implementations, users can submit and/or import their own templates via the mobile application, and can prepare location-conscious mobile banners using their personally-created templates. User-created templates can be reviewed by the location-conscious mobile banner server system to ensure that they meet any requirements established by publishers and/or mobile applications. An exemplary template data structure can take a form similar to the following:

{

“1”: {

“link” : “http://cdpackages.s3.amazonaws.com/template1.png”,
“radius” : 5,
“static” :[

[

{

“views”: [

{

“type”: “image”,
“placeholder”:

“http://cdpackages.s3.amazonaws.com/heading.png”

}

],
“coord”: [250,0,50,50],
“back_color”: [0,0,0,1]

},
{

“views”: [

{

“type”: “image”,
“placeholder”:

“http://cdpackages.s3.amazonaws.com/left_Image.png”

}

],
“coord”: [0,0,50,50],
“back_color”: [0,0,0,1]

}

]

```
  ],
“steps”: [
  [
```

{

“views”: [

{

“type”: “color”,
“title”: “Background Color”,
“key”: “bcolor”

}

],
“coord”: [50,0,200,50],
“back_color”: [128,128,128,1],
“highlight” : “no”

}

],
[

{

“views”: [

{

“type”: “image”,
“title”: “Business Image”,
“key”: “bimage”

}

],
“coord”: [0,0,50,50],
“back_color”: [0,0,0,1],
“text_color”: [255,255,255,1]

]

],
[

{

“views”: [

{

“type”: “image”,
“title”: “Logo”,
“key”: “logo”

}

],
“coord”: [250,0,50,50],
“back_color”: [0,0,0,1],
“text_color”: [255,255,255,1]

]

],
[

{

“views”: [

{

“type”: “text”,
“title”: “Title ”,
“key”: “title”,

“placeholder”: “Line 1 (Business Name)”
}

],
“coord”: [53,0,197,16],
“back_color”: [0,0,0,0],
“text_color”: [255,255,255,1],
“font_height”: 14,
“font”: “Arial-BoldMT”,
“align”:“left”

}

],
[

{

“views”: [

{

“type”: “text”,
“title”: “Caption ”,
“key”: “caption”,

“placeholder”: “Line 2 (add business message)”
}

],
“coord”: [53,16,197,18],
“back_color”: [0,0,0,0],
“text_color”: [255,255,255,1],
“font_eight”: 16,
“font”: “Arial-BoldMT”,
“align”:“left”

},
{

“views”: [

{

“type”: “text”,
“title“: “City ”,
“key”: “bimage”,
“percentage”: 50,
“placeholder”: “City”

},
{

“type”: “text”,
“title”: “State ”,
“key”: “bimage”,
“percentage”: 50,
“maxlength”:2,

“placeholder”: “State”
}

],
“coord”: [53,34,197,16],
“back_color”: [0,0,0,0],
“text_color”: [255,255,255,1],
“font_height”: 14,
“align”:“left”,
“font”: “Arial-BoldMT”,
“seperator”: “ ”

],
{

“views”: [

{

“type”: “text”,
“title”: “Zip ”,
“key”: “zip”,
“percentage”: 50,
“keypad”:“number”,
“maxlength”:5

}

],
“coord”: [0,0,0,0],
“back_color”: [0,0,0,0],
“text_color”: [255,255,255,1],
“font_height”: 14,
“align”:“left”

}

],
[

{

“views”: [

{

“type”: “time”,
“title”: “Start Date ”,
“key”: “startdate”

}

],
“coord”: [0,0,0,0],
“back_color”: [0,0,0,1],
“text_color”: [255,255,255,1],
“font_height”: 14,
“align”:“left”

},
{

“views”: [

{

“type”: “time”,
“title”: “End Date ”,
“key”: “enddate”,
“percentage”: 100

}

],
“coord”: [0,0,0,0],
“back_color”: [0,0,0,1],
“text_color”: [255,255,255,1],
“font_height”: 14,
“align”:“left”

},
{

“views”: [

{

“type”: “text”,
“title”: “Total Cost ”,
“key”: “cost”,
“percentage”: 60,
“keypad”:“number”,
“maxlength”:5

}

],
“coord”: [0,0,0,0],
“back_color”: [0,0,0,1],
“text_color”: [255,255,255,1],
“font_height”: 14,
“align”:“left”

}

]

]

}

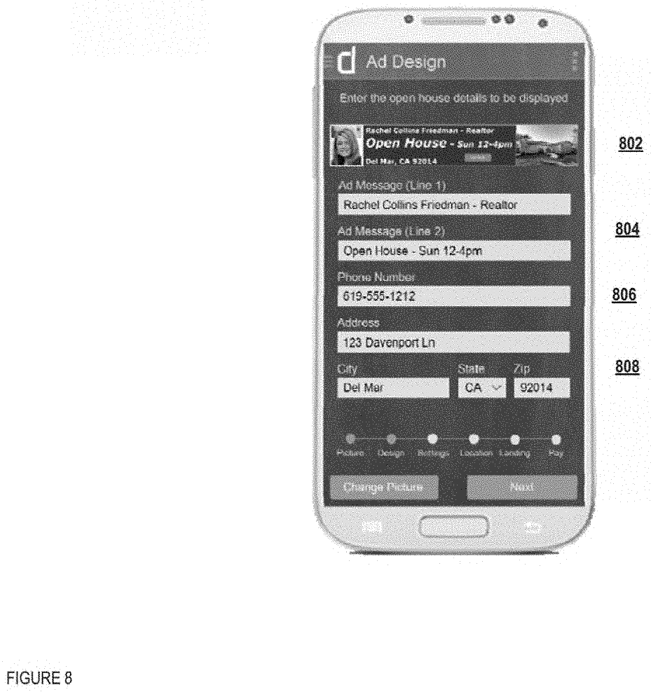

The user 102 can then select one of the templates, e.g., from a list of template previews (e.g., see 706 of FIG. 7), which can allow the user 102 use to enter 116 information requested by the template in order to create the location-conscious mobile banner. For example, referring to FIG. 8, a particular template may include text fields for information that the user 102 can provide for the template (e.g., the user's name, address 808, phone number 806, email address, advertisement and/or notification description 804, and/or similar information). The template may also include components for images, videos, and/or animated images, which can be imported into the location-conscious mobile banner. The user may be able to view a preview 802 of the location-conscious mobile banner as the user 102 provides such data to the template fields.

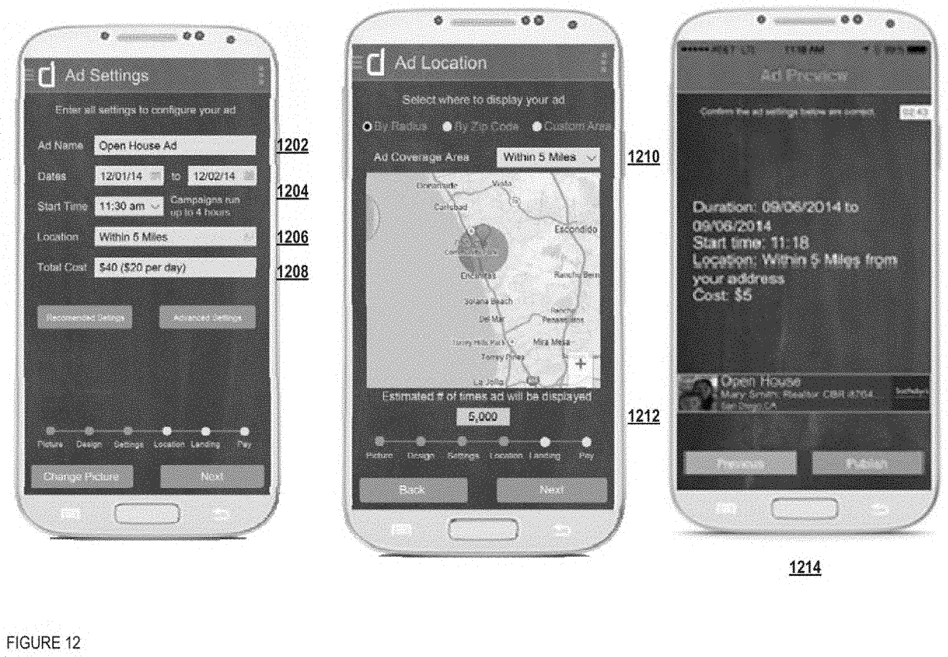

Referring to FIG. 1, once the user 102 has provided information for the template, the mobile application on the user's electronic device 106 can generate a location-conscious mobile banner 118, using the user-provided information. The mobile application can also generate metadata using other information the user 102 can provide regarding the location-conscious mobile banner, including a geolocation in which the location-conscious mobile banner can be displayed, a time period in which to display the location-conscious mobile banner, how much the user 102 would like to spend on the campaign, and/or other such information. For example, referring to FIG. 12, the user 102 may be able to specify a name 1202 for the location-conscious mobile banner. The user 102 can also specify a radius 1206 from the location of a target location (e.g., the location the user 102 enters for the location-conscious mobile banner, and/or another location specified by the user 102), or can specify a neighborhood, city and/or town, a state, and/or a country, in which the location-conscious mobile banner can be displayed for other users to see. The user 102 can enter the information via a text field 1206, and/or via a map interface 1210, which can allow the user 102 to move a location indicator on a map in order to determine a particular location in which to display the location-conscious mobile banner. The mobile application can also provide the user 102 with an estimation 1212 of how many times an ad may be displayed within a particular location (e.g., based on the density of location-conscious mobile banner submitted within the location, and/or the like).

The user 102 can also specify when the location-conscious mobile banner is displayed 1204, e.g., by the mobile application, and/or by third-party publishers who can display the location-conscious mobile banner. The user 102, for example, can select a date and/or a range of dates, as well as a start and/or end time, or a schedule, during which the location-conscious mobile banner can be displayed. The user 102 can also specify an amount the user 102 would like to spend on a campaign 1208; e.g., the user 102 can specify how much money she would like to spend per day, or in aggregate, on providing the location-conscious mobile banner to other users. The cost can, for example, cover fees and/or other expenses associated with requesting external publishers to display the location-conscious mobile banner. As the user 102 provides such information, the user 102 may be able to preview the metadata the user has specified 1214, before submitting the location-conscious mobile banner for publication.

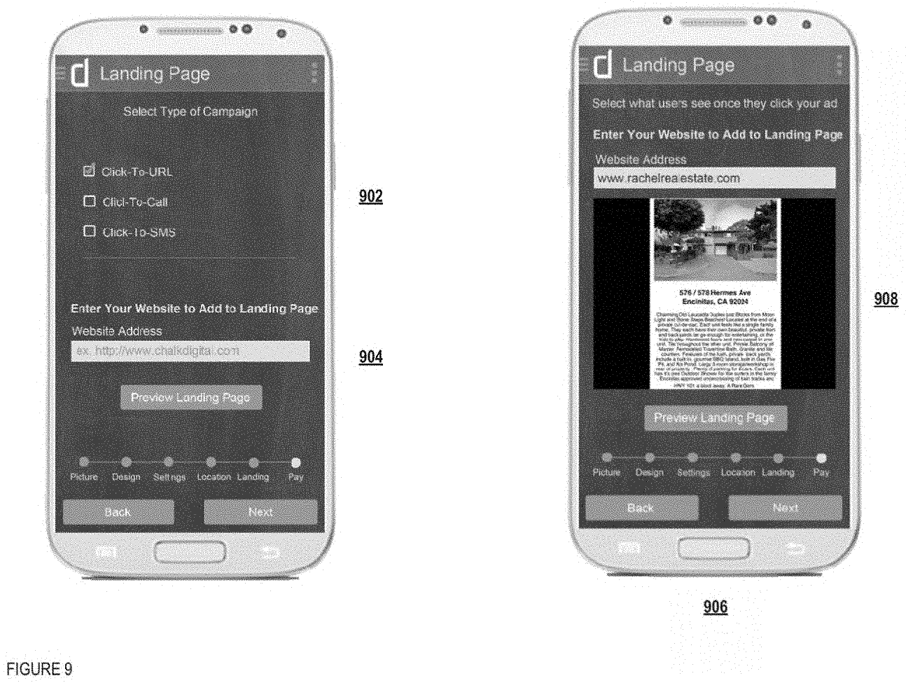

Referring to FIG. 9, in some implementations, the metadata may also include landing page data (e.g., data that is provided to a user who interacts with the location-conscious mobile banner, such as a website address which redirects the user to a specified website), a phone number which is automatically dialed and/or texted when the user interacts with the location-conscious mobile banner, a simple entry form to provide information to be contacted and/or the like. For example, a user may specify that she would like to add a click-to-URL type of campaign 902 (e.g., a campaign which includes a landing page when another user clicks the location-conscious mobile banner). The user can then specify a website 904 to display to the other users, and can preview 906 the landing page in a separate screen. The mobile application can provide a preview window 908 which can display a preview of the specified target website to the user, such that the user can see how other users would view the website after interacting with the location-conscious mobile banner.

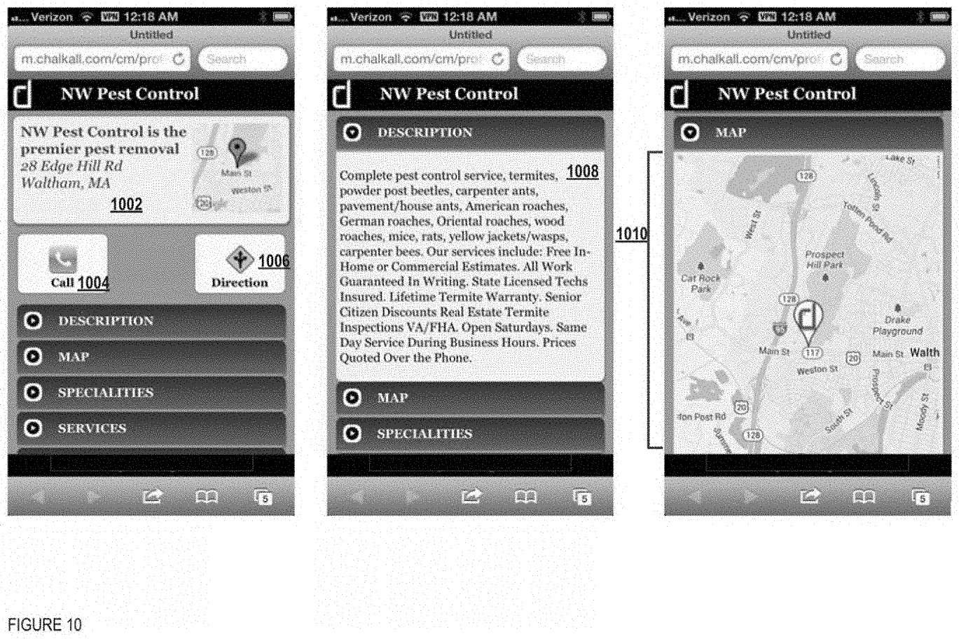

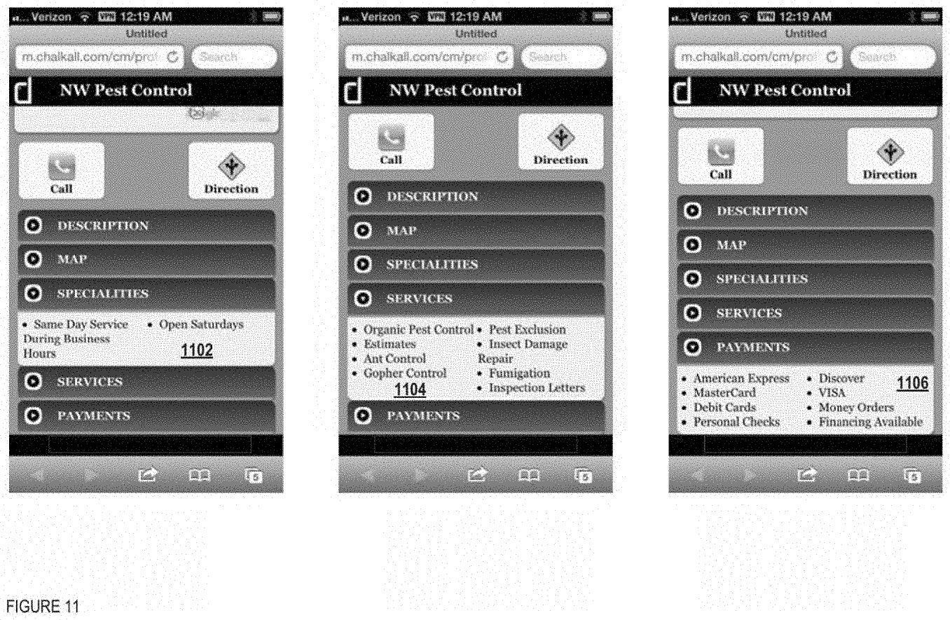

Referring to FIGS. 10-11, a landing page as seen by another user viewing the location-conscious mobile banner can include the address and tagline 1002 in the location-conscious mobile banner, as well as options to call 1004 the user who created the location-conscious mobile banner, and/or to find directions 1006 to the address specified in the location-conscious mobile banner. The user can view a description 1008 of the product, service, event, and/or other notification being represented with the location-conscious mobile banner. The user can also view a map 1010 showing the general location of the provided address. The user can also view a list of specialties 1102 (e.g., if the location-conscious mobile banner creator is providing goods and/or services), services 1104 the location-conscious mobile banner creator can provide (e.g., if the location-conscious mobile banner creator is offering services), as well as payment methods 1106 available (e.g., if the location-conscious mobile banner charges for any goods and/or services).

Referring again to FIG. 1, the generated location-conscious mobile banner can be sent to the banner server 110 from the electronic device 106, e.g., via a new location-conscious mobile banner message 120, which can include a location-conscious mobile banner data structure, the metadata for the location-conscious mobile banner, user information, and/or similar data. The banner server 110 can then store 122 the location-conscious mobile banner data and the associated metadata in a database, e.g., in a location-conscious mobile banner record and a metadata record, respectively, associated with the user 102. The banner server can then provide a copy of the location-conscious mobile banner to the user 124 (e.g., so that the user 102 can share the banner herself, and/or view the final version of the location-conscious mobile banner), and can also provide both the location-conscious mobile banner data and the metadata to a publisher (e.g., via sending the data to a publishing server), e.g., such that the publisher can display the location-conscious mobile banner within other mobile applications, and/or mobile websites.

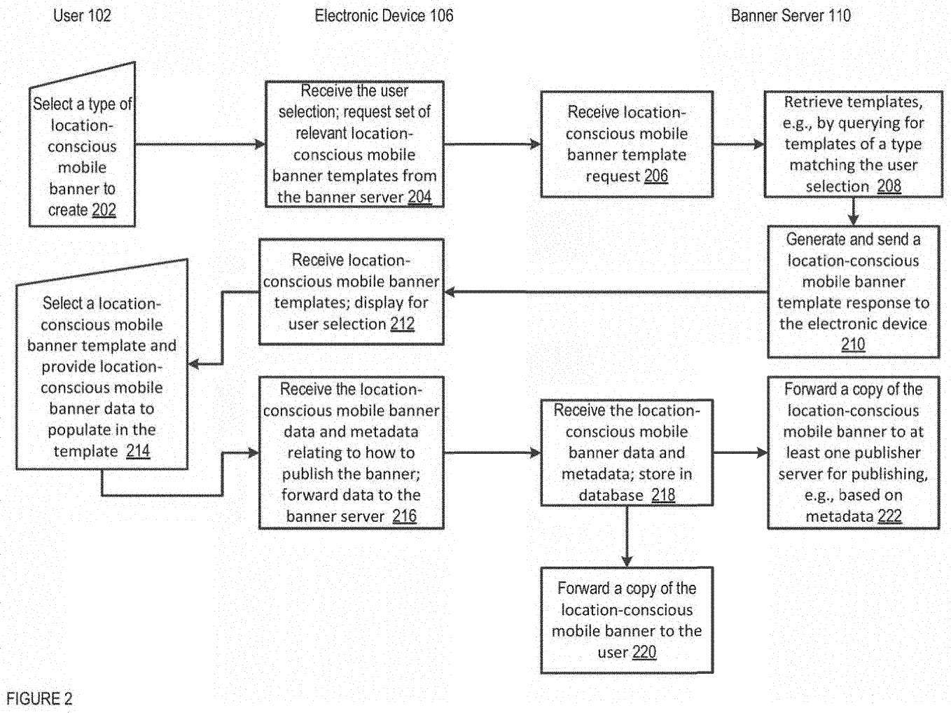

FIG. 2 is a logic flow diagram illustrating creating a location-conscious mobile banner. In some implementations, the user can select 202 a type of location-conscious mobile banner to create, e.g., from a selectable list of options, and/or the like. The user's electronic device 106 an receive the user selection, and use the selection to request 204 a set of relevant location-conscious mobile banner templates from the banner server 110. The banner server 110 can receive the location-conscious mobile banner template request 206, and may retrieve 208 templates, e.g., by querying a database for templates matching the location-conscious mobile banner type that the user selected, and/or similar categories. Once at least one template has been found, the banner server 110 can generate and send 220 a location-conscious mobile banner template response to the electronic device 106, such that when the electronic device 106 receives the location-conscious mobile banner template response, the electronic device 106 can display 212 the available templates to the user for selection. Once a user has selected 214 a location-conscious mobile banner template, the user can also provide relevant information to the template fields, including but not limited to a name for the location-conscious mobile banner, an address and/or other contact information to use in relation to the location-conscious mobile banner, a brief description of the event and/or notice the location-conscious mobile banner is promoting, and/or similar information. The user can also specify metadata describing how the location-conscious mobile banner can be displayed (e.g., where it should be displayed, when it should be displayed, the kind of events that activate when a user clicks and/or otherwise selects the location-conscious mobile banner, e.g., launching a landing page, calling the user, and/or the like, and/or other such criteria).

After the user provides such information to the template on the electronic device 106, the electronic device can create 216 a location-conscious mobile banner data structure and a metadata data structure from the user-provided information. The electronic device 1066 can also forward the created data structures to the banner server 110. The banner server 110 can store 218 the created data structures in a database, and can both forward a copy of the location-conscious mobile banner to the user 220 (e.g., for user review and/or use), and can provide a copy of the location-conscious mobile banner and the metadata to at least one external publisher server 222 for publishing, e.g., within external mobile applications and/or mobile websites. The banner server 110, in some implementations, may modify the location-conscious mobile banner and/or metadata data structures to comport with data structures used by particular publishers (e.g., the banner server can convert a metadata data structure stored as an XML data structure, into a JSON data structure for a publisher server processing JSON data structures, and/or the like).

FIG. 3 is a block diagram illustrating a banner server system 300. In some implementations, a banner server system 300 can include a mobile device executing a mobile application 302 configured to communicate with the banner server 110. The banner server 110 can include at least a memory and a processor and/or a set of processors, and can be configured to store processor-executable instructions in the memory, the instructions informing the processor of how to manage and/or process user, location-conscious mobile banner, and metadata data, and/or how to provide such data to external publishers and/or like entities. The banner server 110 can also include at least a delivery server 304, a location-conscious mobile banner database 306, and a capturing server 308. The delivery server 304 can include at least a memory and a processor and/or a set of processors, and can be configured to store processor-executable instructions in the memory, the instructions informing the processor of how to facilitate communications between the banner server and a publisher server 310, including preparing location-conscious mobile banner data structures and/or metadata for the publisher server 310.

The publisher server can include at least a memory and a processor and/or a set of processors, and can be configured to store processor-executable instructions in the memory, the instructions informing the processor of how to communicate with a publisher application 312, including but not limited to a mobile application and/or mobile website. The publisher application 312 can include a component for displaying location-conscious mobile banner 314. The capturing server 308 can include at least a memory and a processor and/or a set of processors, and can be configured to store processor-executable instructions in the memory, the instructions informing the processor of how to facilitate communications between the banner server and the mobile application 302, including receiving requests to make location-conscious mobile banners from users, providing location-conscious mobile banner templates to users, and/or storing location-conscious mobile banner data in the location-conscious mobile banner database 306. The capturing server 308 can also be configured to establish and/or define campaign information, e.g., based on the location-conscious mobile banner data from a user. Campaign information can include any information provided to publisher servers and/or otherwise used to determine when, where, and/or how to display location-conscious mobile banners created by users.

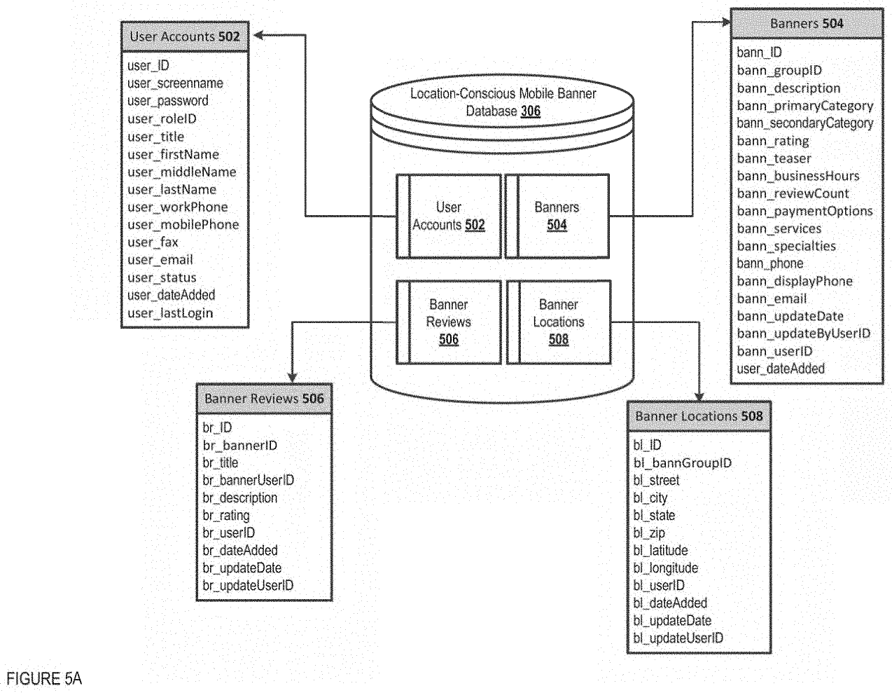

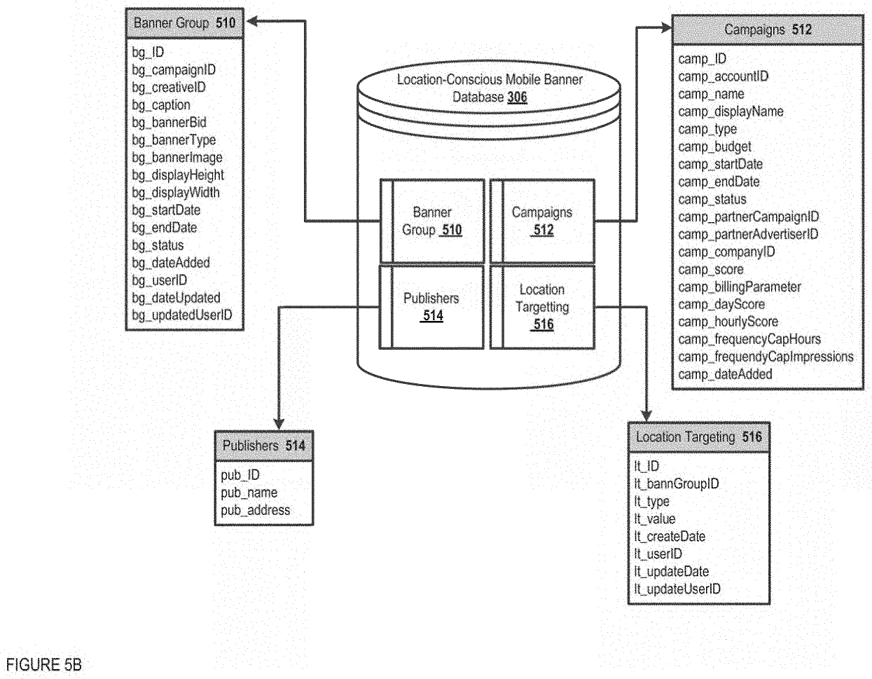

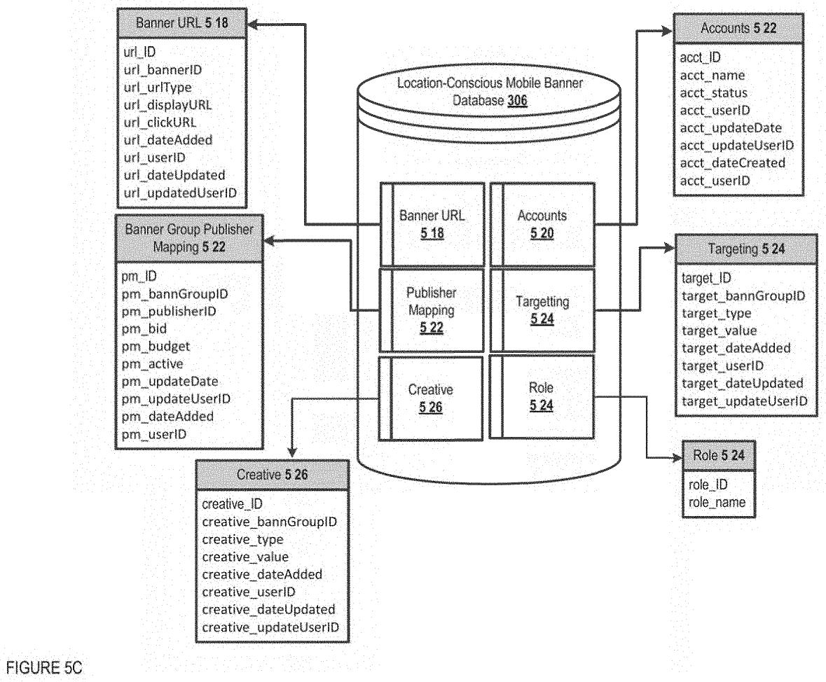

The location-conscious mobile banner database 306 can be a relational database configured to store location-conscious mobile banner data structures, metadata data structures, user profile data structures, and/or other information. Referring to FIGS. 5A-C, the location-conscious mobile banner database 306 can include data tables such as a user accounts table 502, a banners table 504, a banner reviews table 506, a banner locations table 508, a banner group table 510, a campaigns table 512, a publishers table 514, a location targeting table 516, a banner Uniform Resource Locator (URL) table 518, an accounts table 520, a banner group publisher mapping table 522, a targeting table 524, a creative table 526, and/or a role table 524. A user accounts table 502 can store records relating to user accounts. Each record can include at least some of the following attributes: user_ID, user_screenname, user_password, user_roleID, user_title, user_firstName, user_middleName, user_lastName, user_workPhone, user_mobilePhone, user_fax, user_email, user_status, user_dateAdded, and/or user_lastLogin.

A banners table 504 can store records relating to location-conscious mobile banner data structures. Each location-conscious mobile banner data structure can include at least some of the following attributes: bann_ID, bann_groupID, bann_description, bann_primaryCategory (e.g., where categories can include a type of location-conscious mobile banner, e.g., including but not limited to an advertisement and/or a notification), bann_secondaryCategory (e.g., where categories can include a type of industry and/or subject matter in the location-conscious mobile banner), bann_rating, bann_teaser (e.g., a preview and/or thumbnail of the location-conscious mobile banner), bann_businessHours, bann_reviewCount, bann_paymentOptions, bann_services, bann_specialties, bann_phone, bann_displayPhone, bann_email, bann_updateDate, bann_updateByUserID, bann_userID, and/or user_dateAdded. A banner reviews table 506 can store records relating to reviews users submit for particular location-conscious mobile banners and/or their creators. Each record can include at least some of the following attributes: br_ID, br_bannerID, br_title, br_bannerUserID (e.g., the user ID of the user who created the banner), br_description, br_rating, br_userID (e.g., the user ID of the user submitting the review), br_dateAdded, br_updateDate, and/or br_updateUserID (e.g., the user ID of the user who last updated the review).

A banner locations table 508 can include records describing where, geographically, to display a location-conscious mobile banner. Each record can include at least some of the following attributes: bl_ID, bl_bannGroupID, bl_street, bl_city, bl_state, bl_zip, bl_latitude, bl_longitude, bl_userID, bl_dateAdded, bl_updateDate, and/or bl_updateUserID. A banner group table 510 can include records for banner groups (e.g., also referred to herein as banner templates). Each record can include at least some of the following attributes: bg_ID, bg_campaignID, bg_creativeID, bg_caption, bg_bannerBid (e.g., the amount to be spent displaying a location-conscious mobile banner), bg_bannerType (e.g., including but not limited to a textual location-conscious mobile banner, a location-conscious mobile banner with an image, a location-conscious mobile banner with a video and/or animated image, and/or other types of location-conscious mobile banners), bg_bannerImage, bg_displayHeight, bg_displayWidth, bg_startDate (e.g., when the location-conscious mobile banner can begin to be displayed in mobile applications), bg_endDate (e.g., when the location-conscious mobile banner can cease being displayed in mobile applications), bg_status, bg_dateAdded, bg_userID, bg_dateUpdated, and/or bg_updatedUserID.

A campaigns table 512 can include records describing location-conscious mobile banner campaigns. Each record can include at least some of the following attributes: camp_ID, camp_accountID, camp_name, camp_displayName, camp_type (e.g., including but not limited to an advertisement campaign, a missing persons campaign, and/or a political campaign), camp_budget (e.g., how much money a user has allocated towards displaying the location-conscious mobile banner), camp_startDate (e.g., the date at which the campaign is scheduled to start), camp_endDate (e.g., the date at which the campaign is scheduled to start), camp_status, camp_partnerCampaignID, camp_partnerAdvertiserID, camp_companyID, camp_score, camp_billingParameter, camp_dayScore (e.g., a statistical-based score on how well the campaign performed on a particular day), camp_hourlyScore (e.g., a statistical-based score on how well the campaign performed at a particular hour), camp_frequencyCapHours (e.g., a limit on the number of hours the campaign is run), camp_frequencyCapImpressions e.g., a limit on the number of impressions which can be made in relation to the location-conscious mobile banner), and/or camp_dateAdded.

A publishers table 514 can include records describing publishers with which the location-conscious mobile banner can communicate. Each record can include at least some of the following attributes: pub_ID, pub_name, and/or pub_address. A location targeting table 516 can include records describing targeting parameters for a particular location. Each record can include at least some of the following attributes: lt_ID, lt_bannGroupID, lt_type, lt_value, lt_createDate, lt_userID, lt_updateDate, and/or lt_updateUserID. A banner URL table 518 can include records describing landing page parameters for a location-conscious mobile banner. Each record can include at least some of the following attributes: url_ID, url_bannerID, url_urlType, url_displayURL (e.g., how the URL is displayed to other users), url_clickURL (e.g., where other users are redirected when they access the location-conscious mobile banner URL), url_dateAdded, url_userID, url_dateUpdated, and/or url_updatedUserID. An accounts table 520 can include records describing campaign accounts. Each record can include at least some of the following attributes: acct_ID, acct_name, acct_status, acct_userID, acct_updateDate, acct_updateUserID, acct_dateCreated, and/or acct_userID.

A banner group publisher mapping table 522 can include records mapping publishers to location-conscious mobile banner templates. Each record can include at least some of the following attributes: pm_ID, pm_bannGroupID, pm_publisherID, pm_bid, pm_budget, pm_active, pm_updateDate, pm_updateUserID, pm_dateAdded, and/or pm_userID. A targeting table 524 can include records describing targeting parameters for campaigns and/or location-conscious mobile banners. Each record can include at least some of the following attributes: target_ID, target_bannGroupID, target_type, target_value, target_dateAdded, target_userID, target_dateUpdated, and/or target_updateUserID.

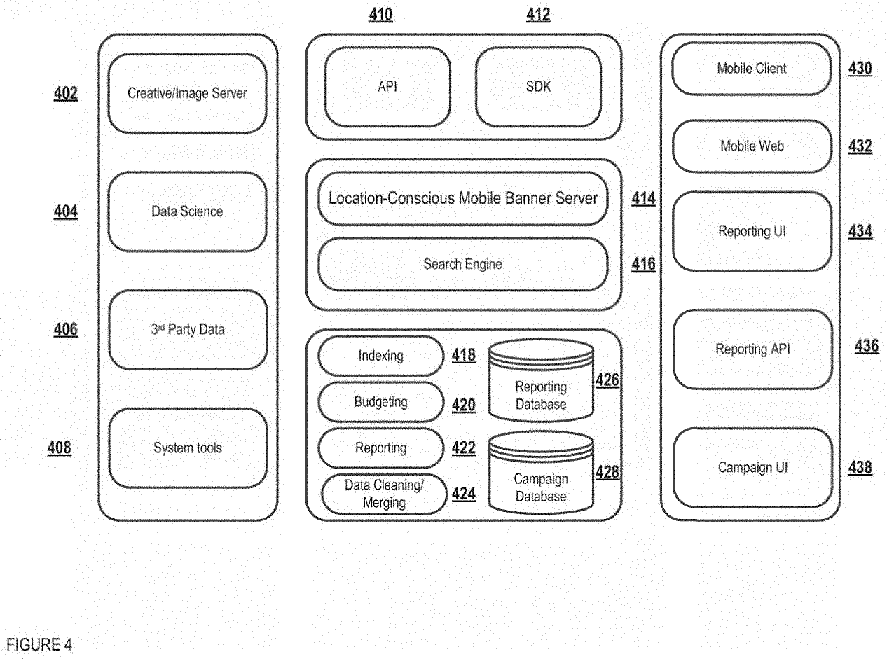

A creative table 526 can include records describing the creative data generated by creative/image server 402 (e.g., see FIG. 4 for more details). Each record can include at least some of the following attributes: creative_ID, creative_bannGroupID, creative type, creative_value, creative_dateAdded, creative_userID, creative_dateUpdated, and/or creative_updateUserID. A role table 524 can include records describing user roles. Each record can include at least some of the following attributes: role_ID and/or role_name.

In some embodiments the delivery server 304 and the capturing server 308 may be physically distinct server units in communication with database 306. In other implementations the banner server 110 may comprise a single server device or cluster configured to perform the functions of delivery server 304 and capturing server 308.

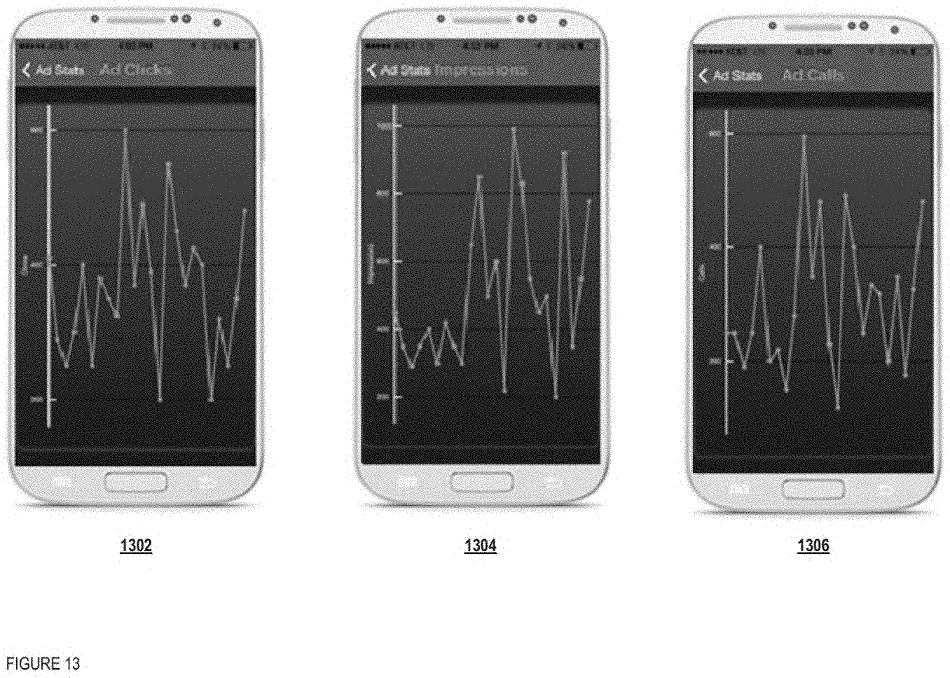

FIG. 4 is a block diagram illustrating a banner server system stack. In some implementations, the banner server system stack can include modules for managing and optimizing the banner server system, modules for communicating with client systems, and modules for creating and storing campaign information. The server system can include a creative/image server 402, a data science module 404, a third-party data module 406, and a system tools module 408. The creative/image server 402 can include at least a memory and a processor and/or a set of processors, and can be configured to store processor-executable instructions in the memory, the instructions informing the processor of how to store and/or serve data obtained from client devices (e.g., user electronic devices and/or similar devices). For example, the creative server can receive data (e.g., binary image data, textual data, and/or similar data) from a user and store it in memory, e.g., as a location-conscious mobile banner image, data structure, and/or a similar file. The creative/image server 402 can generate unique names and/or identifiers for stored location-conscious mobile banner data, and can provide the data to the user for review, e.g., when the user previews and/or requests a copy of a location-conscious mobile banner. The data science module 404 can be implemented either in hardware (e.g., as a computing device including at least a memory and/or a processor) or software (e.g., as a software module executed on a computing device), and can be configured to facilitate tracking of location-conscious mobile banner statistics and/or like data (e.g., see FIG. 13 for more information).

The third-party data module 406 can be implemented either in hardware (e.g., as a computing device including at least a memory and/or a processor) or software (e.g., as a software module executed on a computing device), and can be configured to store third-party data (e.g., census data, business names, location-specific geolocation and/or IP to location addresses), e.g., to optimize functionality within the stack (e.g., to automatically pull business data into a location-conscious mobile banner, and/or for similar purposes). The system tools module 408 can be implemented either in hardware (e.g., as a computing device including at least a memory and/or a processor) or software (e.g., as a software module executed on a computing device), and can be configured to store and implement tools to manage and/or maintain the banner server system, e.g., including but not limited to backing up the system, cleaning up the system (e.g., removing duplicate files, removing corrupted files, and/or the like), and/or alerting the banner server system of any component failures.

In some implementations, the server system can also include an Application Program Interface (API) module 410 and a Software Development Kit (SDK) module 412. The API module 410 can be implemented either in hardware (e.g., as a computing device including at least a memory and/or a processor) or software (e.g., as a software module executed on a computing device), and can be configured to allow the mobile application on an electronic device to communicate with the banner server system. The SDK module 412 can be implemented either in hardware (e.g., as a computing device including at least a memory and/or a processor) or software (e.g., as a software module executed on a computing device), and can be utilized by developers to facilitate such communication functionality within the mobile application.

In some implementations, the server system can also include a location-conscious mobile banner server 414 and a search engine module 416. In some implementations these components can be used to store metadata for location-conscious mobile banners for other components of the banner server system stack.

In some implementations, the server system can also include indexing 418, budgeting 420, reporting 422, and/or data cleaning/merging 424 modules, as well as a reporting database 426 and a campaign database 428. The budgeting module 420 can be implemented either in hardware (e.g., as a computing device including at least a memory and/or a processor) or software (e.g., as a software module executed on a computing device), and can be configured to manage how much has been spent publishing various location-conscious mobile banners in the location-conscious mobile banner database, and/or to restrict publishing of location-conscious mobile banners which have exceeded their specified budget. The reporting module 422 can be implemented either in hardware (e.g., as a computing device including at least a memory and/or a processor) or software (e.g., as a software module executed on a computing device), and can be configured to store reports relating to budgets, campaign delivery, and/or other information relating to campaigns.

In some implementations, the server system can include a mobile client 430, a mobile web 432, a reporting user interface (UI) 434, a reporting API 436, and a campaign UI 438. In some implementations, the mobile client 430 can be the mobile application which runs on a user's electronic device, and can facilitate the creation and management of location-conscious mobile banners by a user.

FIG. 13 is a screenshot diagram illustrating location-conscious mobile banner statistics in a reporting dashboard. In some implementations, the user may be able to view statistical information about their location-conscious mobile banner, e.g., including but not limited to statistical information about how many times a location-conscious mobile banner has been clicked 1302, user impressions regarding the location-conscious mobile banner 1304, how many times other users have called and/or otherwise interacted with the user as a result of the location-conscious mobile banner 1306, a number of times the location-conscious mobile banner has been displayed in at least one mobile application, an amount of money which has been spent to provide the location-conscious mobile banner in the at least one mobile application, and/or a revenue return value.

The user can view the statistical information in order to determine the performance of the location-conscious mobile banner, and can use the statistical information to determine how to modify the location-conscious mobile banner, and/or prepare future location-conscious mobile banners, to improve the statistical data. For example, a user can use a low click count of an active location-conscious mobile banner to infer, for example, that the location-conscious mobile banner is not displaying in the best geographical location, and can modify her location-conscious mobile banner to appear in a different and/or larger location.

Referring to FIG. 14, in some implementations, statistical data may be represented in other formats within the reporting dashboard, e.g., such as on a map. For example, a statistical map 1402 can include markers 1404 indicating users and/or populations of users who have interacted with the location-conscious mobile banner, impressions, and/or similar data. Therefore, based on where the markers are located, a user can determine the geographical density of various interactions with the location-conscious mobile banner, and/or can determine optimal locations to which the location-conscious mobile banner should be provided.

In some configurations, the systems and apparatus described herein include means for performing various functions as described herein. In one aspect, the aforementioned means may be a processor or processors and associated memory in which embodiments reside, and which are configured to perform the functions recited by the aforementioned means. The aforementioned means may be, for example, processor and/or memory modules or apparatus residing in modems to perform the functions described herein. In another aspect, the aforementioned means may be a module or apparatus configured to perform the functions recited by the aforementioned means, such as an application program and/or plug-in to an application program.

In one or more exemplary embodiments, the functions, methods and processes described may be implemented in hardware, software, firmware, or any combination thereof. If implemented in software, the functions may be stored on or encoded as one or more instructions or code on a computer-readable medium. The software may include an application program and/or a plug-in for use with an application program. The application program may be, for example, a mobile application.

Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above can also be included within the scope of computer-readable media.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The illustrated processes present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The scope of the invention is not intended to be limited to the aspects shown herein, but is to be accorded the full scope consistent with the description herein, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the principles and novel features disclosed herein.

What is claimed is:

1. A location-conscious mobile banner apparatus, comprising:
a location-conscious mobile banner database configured to store location-conscious mobile banner data and a location-conscious mobile banner template;
a capturing server operatively coupled to the location-conscious mobile banner database and configured to receive a first request from a user device to create a location-conscious mobile banner and to responsively retrieve the location-conscious mobile banner template from the location-conscious mobile banner database, the capturing server being configured to send to the user device the location-conscious mobile banner template and to receive location-conscious mobile banner data from the user device wherein the location-conscious mobile banner data is consistent with the location-conscious mobile banner template; and
a delivery server operatively coupled to the capturing server and configured to receive from the capturing server the location-conscious mobile banner data, the delivery server being configured to create a location-conscious mobile banner using the location-conscious mobile banner data and to send the location-conscious mobile banner to at least one publisher server;
wherein the at least one publisher server is configured to send the location-conscious mobile banner to at least one mobile device for display by a mobile application executed by the at least one mobile device.

2. The apparatus of claim 1, wherein the location-conscious mobile banner is an advertisement for a product or service.

3. The apparatus of claim 1, wherein the location-conscious mobile banner is a notification of an event or an emergency circumstance,
wherein the emergency circumstance is at least one of a missing person, a missing pet, or severe weather.

4. The apparatus of claim 1, wherein the location-conscious mobile banner template includes layout metadata, location-conscious mobile banner dimension data, and input fields for location-conscious mobile banner data.

5. The apparatus of claim 1, wherein the location-conscious mobile banner data includes at least one of a user name, a user contact address, a user phone number, a textual description, a photo, a video, and landing page data.

6. The apparatus of claim 5, wherein the landing page data includes at least one of a user contact address, a tagline, a map displaying the user contact address, the textual description, specialties data, services data, or available payment methods data.

7. The apparatus of claim 5, wherein the landing page data is displayed to a user if the user interacts with the location-conscious mobile banner data in the at least one mobile application.

8. The apparatus of claim 1, wherein the location-conscious mobile banner data includes metadata relating to a geographical location in which the location-conscious mobile banner is to be displayed by the mobile application.

9. The apparatus of claim 1, wherein the location-conscious mobile banner data includes a time period during which to display the location-conscious mobile banner.

10. A non-transitory processor-readable medium storing code representing instructions to be executed by a processor, the code comprising code to cause the processor to:
receive, from a user device, an indication of interest in creating a location-conscious mobile banner;
retrieve, from a location-conscious mobile banner database, at least one location-conscious mobile banner template based on information included within the indication of interest;
provide the at least one location-conscious mobile banner template to the user device;
receive location-conscious mobile banner template input from the user device, the location-conscious mobile banner template input including geolocation data;
create a location-conscious mobile banner using the location-conscious mobile banner template input from the user; and
send the location-conscious mobile banner for delivery to at least one mobile application executed by a mobile device.

11. The non-transitory processor-readable medium of claim 10, wherein the location-conscious mobile banner is an advertisement for a product or service.

12. The non-transitory processor-readable medium of claim 10, wherein the location-conscious mobile banner is a notification of an event or an emergency circumstance,
wherein the emergency circumstance is at least one of a missing person, a missing pet, or severe weather.

13. The non-transitory processor-readable medium of claim 10, wherein the location-conscious mobile banner template includes layout metadata, location-conscious mobile banner dimension data, and input fields for location-conscious mobile banner data.

14. The non-transitory processor-readable medium of claim 10, wherein the location-conscious mobile banner data includes at least one of a user name, a user contact address, a user phone number, a textual description, a photo, a video, and landing page data.

15. The non-transitory processor-readable medium of claim 14, wherein the landing page data includes at least one of a user contact address, a tagline, a map displaying the user contact address, the textual description, specialties data, services data, or available payment methods data.

16. The non-transitory processor-readable medium of claim 14, wherein the landing page data is displayed to a second user if the second user interacts with the location-conscious mobile banner in the at least one mobile application.

17. The non-transitory processor-readable medium of claim 10, wherein the location-conscious mobile banner data includes a geographical location in which to display the location-conscious mobile banner within the at least one mobile application.

18. The non-transitory processor-readable medium of claim 10, wherein the location-conscious mobile banner data includes a time period during which to display the location-conscious mobile banner within the at least one mobile application.

19. A non-transitory processor-readable medium storing code representing instructions to be executed by a processor, the code comprising code to cause the processor to:
receive, from a user device, location-conscious mobile banner input;
create a location-conscious mobile banner using the location-conscious mobile banner input;
send the location-conscious mobile banner for display in at least one mobile application;
receive location-conscious mobile banner access statistics from the location-conscious mobile banner in the at least one mobile application; and
output the location-conscious mobile banner access statistics to the user device via a graphical user interface.

20. The non-transitory processor-readable medium of claim 19, wherein the location-conscious mobile banner access statistics include a number of times the location-conscious mobile banner has been displayed in at least one mobile application, a number of times the location-conscious mobile banner has been clicked, a number of times a user has called the location-conscious mobile banner creator, and an amount of money which has been spent to provide the location-conscious mobile banner in the at least one mobile application.

21. The non-transitory processor-readable medium of claim 19, wherein the code further comprises code to cause the processor to:
receive, from the user device, updated location-conscious mobile banner input in response to the location-conscious mobile banner access statistics;
create an updated location-conscious mobile banner using the updated location-conscious mobile banner input;
send the updated location-conscious mobile banner for display in at least one mobile application;
receive updated location-conscious mobile banner access statistics from the updated location-conscious mobile banner in the at least one mobile application; and
output the updated location-conscious mobile banner access statistics to the user device via the graphical user interface
